(19) United States
(12) Patent Application Publication
(10) Pub. No.: US 2025/0088795 A1
(43) Pub. Date: Mar. 13, 2025

(54) Muting Specific Talkers Using a Beamforming Microphone Array

(71) Applicant: ClearOne, Inc., Salt Lake City, UT (US)

(72) Inventors: Derek L. Graham, South Jordan, UT (US); David K. Lambert, South Jordan, UT (US); Russell S. Ericksen, Spanish Fork, UT (US); Zeynep Hakimoglu, Salt Lake City, UT (US)

(73) Assignee: ClearOne, Inc., Salt Lake City, UT (US)

(21) Appl. No.: 18/292,543

(22) PCT Filed: Aug. 13, 2022
(86) PCT No.: PCT/IB2022/057595

§ 371 Date: Feb. 2, 2024

Related U.S. Application Data
(60) Provisional application No. 63/260,273, filed on Aug. 14, 2021.

(51) Int. Cl. H04R 3/00; G06F 3/16; G06V 10/77; G06V 20/40; G06V 40/16; G10L 21/028; H04R 5/027

(52) U.S. Cl. CPC H04R 3/005; G06F 3/165; G06V 10/77; G06V 20/41; G06V 40/165; G10L 21/028; H04R 5/027

(57) ABSTRACT

This disclosure describes an invention that that mutes specific talkers using at least one beamforming microphone array 102 that is configured to generate N audio signals 108 where each audio signal is associated with a spatial pickup pattern 130, the microphone array(s) 102 are located in a room 200; a processor 104 and memory 105 operably coupled to the microphone array 102, the processor 104 configured to execute the following steps: (a) selectively mute or unmute an individual talker the room with a mute function 106 that controls whether to mute or unmute the individual talker T1-T7 that is picked up by one or more of the individual audio signals, the mute function 106 includes speech learning that learns to identify different talkers in real time to allow the mute function 106 to identify transitions from one talker to another talker in the room 200, (b) output an audio signal 110 based on the selective muting of the talkers T1-T7 in the room 200.

### CROSS REFERENCE TO RELATED APPLICATIONS

This application claims priority and the benefits of the earlier filed Provisional Application USAN 63,260,273, filed Aug. 14, 2021, which is incorporated by reference for all purposes into this specification.

### TECHNICAL FIELD

This disclosure relates to systems using beamforming microphone arrays. More specifically, this disclosure relates to muting specific talkers using beamforming microphone arrays.

### BACKGROUND ART

The current technology to mute and unmute selected speakers using discrete microphones is to mute the microphones off and on as needed for the selected speakers. For example, a lecture hall in which a lecturer stands or walks in a particular area of the classroom (for example, near a whiteboard) while students sit in a different area of the room. In this application, it may be desirable to allow the lecturer's voice to be captured and recorded or transmitted to remote lecture participants, while conversations between students are muted. In this application, it is desirable for the lecturer, or some other person (i.e. a “producer”) to enable or disable an audience microphone to facilitate a question and answer portion of the lecture.

A conferencing system in a professional home office that is typically used by one or a small number of people, but occasionally could experience interruptions from other people (for example, children, a spouse or significant other, etc.).

A city council meeting, school council meeting, or panel discussion with a group of people seated at a table, and an audience. In this application, all microphones are typically muted except the one belonging to the person who “has the floor”.

A courtroom with seating locations for a judge, prosecuting attorneys, defense attorneys, a court reporter, and witnesses.

In the past, all the previously mentioned applications have successfully used wired or wireless microphones with mute controls to mute or unmute a specific microphone or a group of microphones. With the advent of beamforming microphone arrays (BMAs) with good audio performance that can be installed far from the talker, there is a desire to install microphones in or near the ceiling or in another location. Doing this allows the microphone to blend in with the décor and reduces clutter on the table. A beamformer also eliminates the need for a device (e.g., a wireless handheld microphone) to be passed from person to person.

Unfortunately, there are problems that prevent the use of beamformers to selectively mute or unmute specific talkers in the previously listed applications. One problem is that beamforming microphone arrays do not eliminate audio pickup from directions other than their main direction of look also known as a direction of arrival determination. BMAs can significantly attenuate audio propagating to the array from undesired directions, but the spatial filters are not “brick wall” filters that totally mute audio propagating towards the array from an undesired direction. Also, even if it were possible to design spatial filters that completely muted audio coming from undesired directions, the main lobe of the BMA in the desired direction of look has an angular coverage pattern that typically picks up more than one seating location, so different talkers are generally picked up by a single beam. Also, audio sources that are not in the direction of look can reflect off one or more surfaces which can place the audio from those sources in the direction of look.

Because of the applications listed and the lack of a good solution, there is a need for an invention that will allow selective muting or unmuting of specific voices in applications such as sound reinforcement and conferencing that include beamforming microphone arrays.

In systems that incorporate one or more microphone arrays, multiple audio signals are captured by each array. Users of these systems are generally positioned at different locations around a working space. The microphone array(s) creates multiple audio streams, each stream corresponding to a microphone in the array. These audio streams are sent to a processor that performs a beamforming operation. This beamforming operation creates several beams that is less than or greater than the number of microphones in the array.

The BMAs may form multiple beams, and each of those beams may be designed to have a fixed direction of look. The BMA may then be designed so that it provides information on its overall “direction of look” or direction of arrival, which in this case, corresponds to the selected active beam(s) based on speech activity. The BMA may also provide an estimate of the distance of the talker to the array.

The beamformed audio described above may be sent to an automatic mixer that performs various audio processing functions, one of which may include implementing a “gating” function that applies attenuation to audio streams that have very low signal energy, while not attenuating other streams that have high signal energy. Another processing function implemented in the automatic mixer may include using Artificial Intelligence (AI), Machine Learning (ML), or Deep Learning Networks (DLN) to denoise and/or mute beamformed audio containing speech. In the prior art, a Deep Learning Network is trained on a pre-recorded database of non-speech sounds and after training, that system can significantly suppress the non-speech noise, while allowing speech to be transmitted. This prior art does not incorporate a way to selectively mute or unmute different talkers who may be using the system at the same time. The focus in the prior art is to eliminate background noise. If the beamformed audio contains only background noise, the prior art will effectively mute the audio from that beam.

A technology known in the prior art is “speaker diarization”, which determines “who spoke when” using a database of recorded speech. Some prior art incorporates the use of beamformers to perform this diarization with the front-end processing and feature extraction stage including denoising, dereverberation, and speech separation or target speaker extraction. Feature extraction of voices includes extracting the spectrum with time, using any one of a variety of different types of spectrums such as Mel spectrum, Bark spectrum, or ERB spectrum. From the spectra, voice characteristics are labeled. Features extracted may include, for example, cepstral coefficients, entropy, flux, pitch envelope, kurtosis, spread, slope, and any characteristic in the voice spectrum that aids to identify individual voices. Time-domain methods such as speech envelope rise, and decay rate may be incorporated to characterize a person's voice. Denoising incorporates methods to suppress diffuse background noise. Dereverberation incorporates methods to reduce the contribution of reverberant, indirect path speech transmissions into the microphone system. One example method for dereverberation is Weighted Prediction Error. The goal of the Segmentation step is to identify when there is a change from one active talker to another. The Speaker Embedding and Labeling step assigns labels to the different talkers identified in the recording. The Clustering and Post Processing steps are included to improve the accuracy of the diarization process.

For applications such as video recording of lectures and video conferencing, there are products called “voice tracking cameras” that integrate a microphone array with one or more cameras. The cameras in these systems implement pan, tilt, and zoom (PTZ) functions that steer the camera to point in the direction of an active talker based on information provided by the integrated microphone array. A system integrator may have the ability to program preset positions for the pan, tilt, and zoom functions for the camera that correspond to the reported directions of look of the microphone array. Alternatively, the system integrator may allow the camera to dynamically track speech sources wherever they are detected in the room by the camera.

The current technology is described in these references:

PLT1: US20130294612A1. Title: Automatic microphone muting of undesired noises by microphone arrays. This disclosure describes methods and systems for cancelation of table noise in a speaker system used for video or audio conferencing are disclosed. Table noise is cancelled by using a vertical microphone array to distinguish the tilt angle of sound received by a microphone. If the sound is close to horizontal, the audio is muted. If the sound is above a given angle from horizontal, it is not muted, as this indicates a person speaking. This eliminates paper rustling; keyboard clicks and the like. In contrast, however, the current disclosure provides muting/unmuting of a particular talker with a beamformer. This reference is incorporated by reference for all purposes into this disclosure.

PLT2: U.S. Pat. No. 7,415,117B2. Title: System and method for beamforming using a microphone array. This disclosure describes the ability to combine multiple audio signals captured from the microphones in a microphone array is frequently used in beamforming systems. Typically, beamforming involves processing the output audio signals of the microphone array in such a way as to make the microphone array act as a highly directional microphone. In other words, beamforming provides a “listening beam” which points to a particular sound source while often filtering out other sounds. A “generic beamformer,” as described as described in this disclosure automatically designs a set of beams (i.e., beamforming) that cover a desired angular space range within a prescribed search area. Beam design is a function of microphone geometry and operational characteristics, and of noise models of the environment around the microphone array. One advantage of the generic beamformer is that it is applicable to any microphone array geometry and microphone type. In contrast, however, the current disclosure uses AI, ML, or DL networks to identify individual talkers and provide muting/unmuting on a talker-by-talker basis. This reference is incorporated by reference for all purposes into this disclosure.

PLT3: US20130044893A1. Title: System and method for muting audio associated with a source. This disclosure describes in one embodiment, a method includes receiving audio at a plurality of microphones, identifying a sound source to be muted, processing the audio to remove sound received from the sound source at each of the microphones, and transmitting the processed audio. An apparatus is also disclosed. In contrast, however, the current disclosure uses AI, ML, or DL networks to identify individual talkers and provide muting/unmuting on a talker-by-talker basis from beamformed audio signals rather than the individual microphone signals. This reference is incorporated by reference for all purposes into this disclosure.

This application incorporates technology from other patents owned by the Applicant that include: USAN 15190414 now U.S. Pat. No. 11,272,064, titled: Conferencing Apparatus, filed Jun. 23, 2016; and USPN 10728653, titled: Ceiling Tile Microphone, filed Jul. 25, 2016; USAN 63174884, titled: Wideband Beamforming with Interference Cancellation at Multiple Independent Frequencies and Spatial Locations, filed Apr. 14, 2021; all of which are incorporated by reference for all purposes into this disclosure.

### Technical Problem

There is a need for muting specific talkers or sounds using a beamforming microphone array installed in a conferencing environment such as a conference room whether the array may be located in one or more ceiling tiles for example.

### Solution to Problem

This invention relates to beamforming microphone arrays and augments their signal processing capability, voice lift, and other applications. It provides improved flexibility with the additional mute/pass function using beams of a beamformer to selectively mute/unmute one or more specific talkers or sounds in a room.

As an alternative to a voice tracking camera with an integrated microphone array, a BMA may be implemented in the form of a ceiling tile. During installation of the system made up of the BMA ceiling tile and a PTZ camera, the system integrator may note, for example, that when the BMA reports that “beam 1 on BMA 1 is active”, the PTZ camera should point to a chair on the right side of the room. This can be set by a camera controller (like a remote-control device) and programmed as a camera preset. Corresponding presets can be programmed when the BMA reports that other beams are active.

Alternatively, the BMA may implement one or more dynamic beams that steer from talker to talker in real time. In this case, the system integrator, or control system programmer, would take the reported direction of look of the dynamic beams and optionally a distance estimate from the BMA to the talker and map the coordinates of the talker into PTZ controls for the cameras. The mapping may be designed based on the reported coordinates of the talker and the known camera location relative to the BMA in a shared coordinate system which is mapped onto the room that all system components are installed in.

Additionally, the BMA may provide information that sound is coming from predefined undesired areas. During these times the BMA may block the incoming audio, prevent selection of the beam, or prevent a change in steering so that the undesirable audio is not heard by the participants. Undesired areas may include nearby spaces that are outside of the meeting area such as hallways, outdoors, windows, adjacent meeting spaces, desks, and adjoining rooms.

Additionally, the BMA may incorporate a voice activity detector, so that the undesired noise does not activate a beam, or gate a beam on, and only voice activates a beam or causes it to gate on. Noise suppression algorithms may also be incorporated that estimate speech from noise, and thus prevent impulse and/or diffuse noise sources from activating a beam and thus further help prevent the camera from moving to the noise source.

Besides just voice feature extraction, speech denoising by means of Machine Learning, AI, or Deep Learning is a prior art technique that can also be included in processing. Here, noises are learned such that noise can be separated from noisy speech. Typical noises to eliminate are keyboard strokes, dogs barking, babies crying, sirens, washing machines, or any undesirable noise that perturbs the clarity of speech. AI, ML, or DL networks learn the noise amongst a variety of voices and the network learned model is captured.

Another technology known in the prior art is face recognition. There are also techniques that can be performed on video recordings to indicate whether a person is talking or not.

One problem with the prior art techniques in speech diarization, including the methods of diarization based on beamforming, is that they rely on the availability of a pre-recorded database of speech. However, for a conferencing system that is to be deployed in a commercial conference room, a pre-recorded database of the users' voices is typically not available for use when the system is installed.

### Advantageous Effects of Invention

The new function is control of passing or muting specific voices in a conference room with a beamformer's beams providing the audio pick-up and facilitating voice feature extraction.

The mute/pass function uses Machine Learning, Artificial Intelligence, or Deep Learning to extract features of participants' voice(s).

De-noising through AI, ML, DL by training networks with a large set of noises and speech sources allows the beamformer to de-noise speech. Learned networks become part of the processing to separate speech from noisy speech.

### SUMMARY OF INVENTION

This disclosure describes an apparatus and method of an embodiment of an invention that that mutes specific talkers using beamforming microphone arrays. This embodiment of the apparatus/system includes at least one microphone array configured for beamforming where an individual microphone array includes a plurality of microphones where each individual microphone is configured to sense audio signals and the microphone array is configured to generate N audio signals where each audio signal is associated with a spatial pickup pattern, the microphone array(s) are located in a room; a processor and memory operably coupled to the microphone array, the processor configured to execute the following steps: (a) selectively mute or unmute an individual talker the room with a mute function that controls whether to mute or unmute the individual talker that is picked up by one or more of the individual audio signals, the mute function includes speech learning that learns to identify different talkers in real time to allow the mute function to identify transitions from one talker to another talker in the room, (b) output an audio signal based on the selective muting of the talkers in the room.

The above embodiment of the invention may include one or more of these additional embodiments that may be combined in all combinations with the above embodiment. One embodiment of the invention describes where the mute function uses one or more of the following techniques to assist in identifying individual talkers: artificial intelligence, machine learning, or deep learning. One embodiment of the invention further includes at least one video camera that uses facial recognition and/or mouth-movement detection to assist in the learning and identifying of the individual talkers. One embodiment of the invention further includes a user interface so that a user can selectively mute a sound source and/or one or more individual talkers. One embodiment of the invention further includes a diarization function configured to assist in identifying the individual talkers. One embodiment of the invention further includes a speaker separation function configured assist in separating the individual talkers in an audio signal.

The present disclosure further describes an apparatus and method of an embodiment of the invention as further described in this disclosure. Other and further aspects and features of the disclosure will be evident from reading the following detailed description of the embodiments, which should illustrate, not limit, the present disclosure.

### BRIEF DESCRIPTION OF DRAWINGS

The drawings accompanying and forming part of this specification are included to depict certain aspects of the disclosure. A clearer impression of the disclosure, and of the components and operation of systems provided with the disclosure, will become more readily apparent by referring to the exemplary, and therefore non-limiting, embodiments illustrated in the drawings, where identical reference numerals designate the same components. Note that the features illustrated in the drawings are not necessarily drawn to scale. The following is a brief description of the accompanying drawings:

FIG. 1 is a block diagram of a system including a beamforming microphone array and a muting function according to some embodiments.

FIG. 2 is a top-view map-type diagram of a room with a system including a beamforming microphone array and a muting function according to some embodiments.

FIG. 3 is a top-view map-type diagram of another room with a system including a beamforming microphone array and a muting function according to some embodiments.

FIG. 4 is a block diagram of a beamforming microphone array with a muting function according to some embodiments.

FIG. 5 is a block diagram of a system including a beamforming microphone array and a muting function for multiple beams according to some embodiments.

FIG. 6 is a block diagram of a system including a beamforming microphone array and a muting function for a combined audio signal according to some embodiments.

FIG. 7 is a block diagram of a system including a beamforming microphone array and a muting function and an unmuted output according to some embodiments.

FIG. 8 is a block diagram of a system including a beamforming microphone array and a muting function and additional processing according to some embodiments.

FIG. 9 is a flowchart of an operation of a system including a beamforming microphone array and a muting function according to some embodiments.

FIG. 10 is a flowchart of a method for identifying a potential sound source in a system including a beamforming microphone array and a muting function according to some embodiments.

FIG. 11 is a block diagram of an audio signal flow according to some embodiments.

FIG. 12 is a block diagram of a system including a beamforming microphone array and a muting function with a user interface according to some embodiments.

### DESCRIPTION OF EMBODIMENTS

The disclosed embodiments should describe aspects of the disclosure in sufficient detail to enable a person of ordinary skill in the art to practice the invention. Other embodiments may be utilized, and changes may be made without departing from the disclosure. The following detailed description is not to be taken in a limiting sense, and the present invention is defined only by the included claims.

Specific implementations shown and described are only examples and should not be construed as the only way to implement or partition the present disclosure into functional elements unless specified otherwise in this disclosure. A person of ordinary skill in the art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Benefits, other advantages, and solutions to problems are shown and described with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In the following description, elements, circuits, functions, and devices may be shown in block diagram form in order not to obscure the present disclosure in unnecessary detail. And block definitions and partitioning of logic between various blocks are exemplary of a specific implementation. It will be readily apparent to a person of ordinary skill in the art that the present disclosure may be practiced by numerous other partitioning solutions. A person of ordinary skill in the art would understand that information and signals may be represented using any of a variety of technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, where the bus may have a variety of bit widths and the present disclosure may be implemented on any number of data signals including a single data signal.

The illustrative functional units include logical blocks, functions, modules, circuits, and devices described in the embodiments disclosed in this disclosure to emphasize their implementation independence more particularly. The functional units may be implemented or performed with a general-purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described in this disclosure. A general-purpose processor may be a microprocessor, any conventional processor, controller, microcontroller, or state machine. A general-purpose processor may be considered a special purpose processor while the general-purpose processor is configured to fetch and execute instructions (e.g., software code) stored on a computer-readable medium such as any type of memory, storage, and/or storage devices. A processor may also be implemented as a combination of computing devices, such as a combination of a DSP and a microprocessor, a plurality of microprocessors, one or more microprocessors in conjunction with a DSP core, or any other such configuration.

In addition, the illustrative functional units described above may include software, programs, or algorithms such as computer readable instructions that may be described in terms of a process that may be depicted as a flowchart, a flow diagram, a structure diagram, or a block diagram. The process may describe operational acts as a sequential process, many acts can be performed in another sequence, in parallel, or substantially concurrently. Further, the order of the acts may be rearranged. In addition, the software may comprise one or more objects, agents, threads, lines of code, subroutines, separate software applications, two or more lines of code or other suitable software structures operating in one or more software applications or on one or more processors. The software may be distributed over several code segments, modules, among different programs, and across several memory devices. Similarly, operational data may be identified and illustrated in this disclosure within modules and may be embodied in any suitable form and organized within any suitable data structure. The operational data may be collected as a single data set or may be distributed over different locations including over different storage devices. Data stated in ranges include each and every value within that range.

Elements described in this disclosure may include multiple instances of the same element. These elements may be generically indicated by a numerical designator (e.g., 110) and specifically indicated by the numerical indicator followed by an alphabetic designator (e.g., 110A) or a numeric indicator preceded by a “dash” (e.g., 110-1). For ease of following the description, for the most part, element number indicators begin with the number of the drawing on which the elements are introduced or most discussed. For example, where feasible elements in Drawing 1 are designated with a format of 1xx, where 1 indicates Drawing 1 and xx designates the unique element.

Any reference to an element in this disclosure using a designation such as “first,” “second,” and so forth does not limit the quantity or order of those elements, unless such limitation is explicitly stated. Rather, these designations may be used in this disclosure as a convenient method of distinguishing between two or more elements or instances of an element. A reference to a first and second element does not mean that only two elements may be employed or that the first element must precede the second element. In addition, unless stated otherwise, a set of elements may comprise one or more elements.

Reference throughout this specification to “one embodiment”, “an embodiment” or similar language means that a particular feature, structure, or characteristic described in the embodiment is included in at least one embodiment of the present invention. Appearances of the phrases “one embodiment”, “an embodiment” and similar language throughout this specification may, but do not necessarily, all refer to the same embodiment.

In the following detailed description, reference is made to the illustrations, which form a part of the present disclosure, and in which is shown, by way of illustration, specific embodiments in which the present disclosure may be practiced. These embodiments are described in sufficient detail to enable a person of ordinary skill in the art to practice the present disclosure. However, other embodiments may be utilized, and structural, logical, and electrical changes may be made without departing from the true scope of the present disclosure. The illustrations in this disclosure are not meant to be actual views of any particular device or system but are merely idealized representations employed to describe embodiments of the present disclosure. And the illustrations presented are not necessarily drawn to scale. And elements common between drawings may retain the same or have similar numerical designations.

It will also be appreciated that one or more of the elements depicted in the drawings can also be implemented in a more separated or integrated manner, or even removed or rendered as inoperable in certain cases, as is useful in accordance with a particular application. Additionally, any signal arrows in the drawings should be considered only as exemplary, and not limiting, unless otherwise specifically noted. The scope of the present disclosure should be determined by the following claims and their legal equivalents.

As used in this disclosure, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Furthermore, the term “or” as used in this disclosure is generally intended to mean “and/or” unless otherwise indicated. For example, a condition A or B is satisfied by any one of the following: A is true (or present) and B is false (or not present); A is false (or not present) and B is true (or present); and both A and B are true (or present). As used in this disclosure, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description in this disclosure, the meaning of “in” includes “in” and “on” unless the context clearly dictates otherwise.

The claims following this written disclosure are expressly incorporated into the present written disclosure, with each claim standing on its own as a separate embodiment. This disclosure includes all permutations of the independent claims with their dependent claims. Further, additional embodiments capable of derivation from the independent and dependent claims that follow are also expressly incorporated into the present written description.

To aid any Patent Office and any readers of any patent issued on this disclosure in interpreting the included claims, the Applicant(s) wish to note that they do not intend any of the appended claims or claim elements to invoke 35 U.S.C. 112(f) (previously 35 U.S.C. 112(6)) unless the words “means for” or “step for” are explicitly used in that claim. Additionally, if any elements are specifically recited in means-plus-function format, then those elements are intended to be construed to cover the corresponding structure, material, or acts described in this disclosure or additional equivalents in accordance with 35 U.S.C. 112(f) (previously 35 U.S.C. 112(6)).

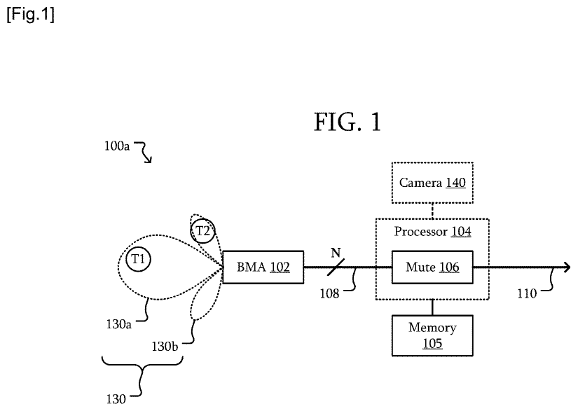

FIG. 1 is a block diagram of a system 100a including a beamforming microphone array (BMA) 102 and a muting function according to some embodiments. The system 100a also includes a processor 104 and a memory and/or storage (memory) 105.

The BMA 102 may include a microphone array including a plurality of microphones configured to transform sound into electrical signals representing multiple audio streams with each stream corresponding to a microphone in the array. The BMA 102 may include circuitry and/or audio signal processing configured to receive the electrical signals from the microphone array and perform one or more beamforming operations to combine those electrical signals into one or more audio signals 108. The BMA 102 is configured to generate N audio signals 108 where N is a positive integer. The number of audio signals 108 may be greater than, less then, or the same as the number of microphones. The various operations described in this disclosure may be performed with respect to a single audio signal 108 while others are performed using multiple audio signals 108.

The processor 104 may include a general-purpose processor, a digital signal processor (DSP), an application specific integrated circuit (ASIC), a microcontroller, a programmable logic device such as a field programmable gate array (FPGA), discrete circuits, a combination of such devices, or the like. Although only one processor 104 is illustrated in the system 100a, multiple processors 104 and/or multiple processor cores may be present.

The processor 104 may be coupled to the memory 105. The memory 105 may be any device capable of storing data. One memory 105 is illustrated for system 100a; however, any number of memories 105 may be included in the system 100a, including different types of memories. Examples of the memory 105 include a dynamic random access memory (DRAM) module, static random access memory (SRAM), non-volatile memory such as Flash, spin-transfer torque Mageneto resistive random access memory (STT-MRAM), or Phase-Change RAM, magnetic or optical media, or the like. The memory 105 or processor 104 may include an encryption function to encrypt data to prevents stored speech data or extracted speech features from being accessed without proper authentication.

In some embodiments, the processor 104 and the memory 105 are part of a single unit, integrated in a single housing, or the like. In other embodiments, the processing, operation, storage, or the like of the processor 104 and the memory 105 may be distributed across multiple components in separate locations linked by various communication interfaces such as analog interfaces, digital interfaces, Ethernet, Fiber Channel, universal serial bus (USB), WIFI, or the like (not shown).

The processor 104 is coupled to the BMA 102 and may be in the same housing (even on the same printed circuit board (PCB)) as the BMA 102 or a separate housing. The processor 104 is configured to receive the audio signals 108. The processor 104 may be configured to perform a variety of operations on the audio signals 108. In some embodiments, the processor 104 is configured to selectively mute a sound source in the audio signals 108 as represented by a mute function 106. A sound source in the audio signals 108 includes any source that contributes to the audio signal 108. For example, a sound source may include a talker that is within a beam of the BMA 102. The mute function 106 is configured to process the audio signals 108 to substantially reduce or eliminate the contribution of the sound source. The reduction or elimination of the contribution of a particular sound source to an audio signal 108 may be referred to as muting the sound source.

Each audio signal 108 is associated with a spatial pickup pattern where sound from some directions is attenuated more than other directions. The pickup pattern associated with an audio signal 108 may also be referred to as a beam or beam pattern. Here, a single pickup pattern 130 is illustrated as an example; however, in other embodiments, the BMA 102 may have multiple pickup patterns. Some of the audio signals 108 may be associated with different pickup patterns while others are associated with the same pickup pattern. The pickup pattern may be fixed, time varying, dynamic, selectable, steerable, or the like. Some of the audio signals 108 may be associated with fixed pickup patterns while others are associated with dynamic pickup patterns.

The processor 104 is coupled to one or more video cameras 140 for use in video conferencing. Facial recognition may be performed on the video generated by the camera 140. The recognized face may be correlated with a talker or sound source. A position of the camera 140, a position of a recognized face in video from the camera 140, a configuration of the BMA 102, the pickup pattern 130 of the BMA 102 for a particular audio signal 108, or the like may be combined to correlate the recognized face with a position and/or a particular talker. The spatial area covered by the camera 140 may be correlated with one or more pickup patterns 130 of an audio signal 108 may cover a spatial area including the position of the recognized face. When audio is received through that particular audio signal 108 associated with a pickup pattern 130 that covers a spatial area covered by the camera 140, the recognized face may be associated with the sound source.

The processor 104 is configured to output the modified audio signal 110 based on the selective muting of the sound source. In a particular example, the system 100a may be disposed such that a pickup pattern 130 of the BMA 102 is directed at a variety of sound sources. Here, two sound sources, talker T1 and talker T2 are illustrated as examples.

A BMA, such as the BMA 102, may not completely eliminate audio pickup from directions other than their main lobe 130a. In this example, talker T1 is within a main lobe 130a of the pickup pattern 130, while talker T2 is within one of multiple side lobes 130b of the pickup pattern 130. While the BMA 102 may significantly attenuate audio propagating to the array from undesired directions, the spatial filtering is not a “brick wall” filter that completely mutes audio propagating towards the BMA 102 from an undesired direction. Even if it were possible to design spatial filters that completely mute audio coming from undesired directions, the main lobe 130a of the BMA 102 in the desired direction of look or direction of arrival has an angular coverage pattern that may pick up more than one sound source, seating location, or the like. As a result, different talkers are generally picked up by a single beam and will appear in the associated audio signal 108. In addition, even if the pickup pattern 130 did not have side lobes 130b that covered talker T2, sound from talker T2 may reflect off surfaces in the area and appear to be in the direction covered by the main lobe 130a. Accordingly, sound from both talkers T1 and T2 will contribute to an audio signal 108 associated with the pickup pattern 130.

The mute function 106 may be configured to mute talker T2 as an example. When activated, the mute function 106 may process the audio signal 108 such that sound from talker T2 is reduced or eliminated, that is, muting talker T2 in the audio signal 108. As a result, a contribution from talker T2 to an output audio signal 110 may be muted. At the same time, the contribution from talker T1 to the audio signal 108 and hence, the output audio signal 110, may be substantially unchanged.

The operation of the mute function 106 may be performed in a variety of ways. For example, artificial intelligence, machine learning, deep learning, signal recognition, or the like may be used to recognize types of sounds. The memory 105 may be configured to store feature data associated with talker T2. The mute function 106 may be configured to use the feature data and the recognition technique to recognize and mute the particular voice of talker T2 in the audio signal 108. As will be described in further detail below, the system 100a may be trained to recognize sound sources, identify sound source, and separate sound sources from others.

The mute function 106 may be selective. For example, in some instances, audio from talker T2 may be desirable. Although capable of muting talker T2, the mute function 106 may be controlled to pass audio matching talker T2. Later, the operation of the mute function 106 may be changed so that audio from talker T2 is muted. As will be described in further detail below, in some embodiments, a user interface may be used to control the selectivity of the mute function 106.

While a sound source to be muted by the mute function 106 has been described as being present within a side lobe 130b of the pickup pattern 130, in other embodiments the sound source may be present within the main lobe 130a of the pickup pattern, or the main lobe or side lobes of a different pickup pattern associated with another audio signal 108.

Using the example above, the contribution of either talker T1, T2, or both may be muted in the modified audio signal 110. While two talkers T1 and T2 have been used as an example, the number of sound sources may be different. For example, any number of sound sources may be present in the pickup pattern 130, including the main lobe 130a, other main lobes (not illustrated), or any side lobes 130b. Any or all of those sound sources may be muted by the mute function 106 so that the corresponding contribution to the modified audio signal 110 is muted.

In some embodiments, a BMA 102 may be installed in a ceiling, wall, or in another location further away from a user in contrast to a collocated microphone, such as a headset microphone, a gooseneck microphone, omnidirectional microphone, or the like. Such collocated microphones may include a button, switch, or other control that allows the user to selectively mute themselves. As a result, when using a BMA 102 a talker may have lost the ability to selectively mute themselves at the collocated microphone. As will be described below, a user interface may allow one or more users to selectively mute themselves or other sound sources.

The pickup pattern 130 may be broader than that of a collocated microphone. As a result, multiple talkers may be present within the pickup pattern 130 of the BMA 102. The associated audio signal 108 may be completely muted, any talker within the pickup pattern 130 may be muted. However, muting an audio signal 108 may not be sufficient to effectively mute a particular talker. While muting an audio signal 108 in which the talker is within a main lobe 130a of the associated pickup pattern 130, the talker may still be within a side lobe or main lobe of one or more other beams. The sound from the talker may still be present in a combination of audio signals from the various beams even if the audio signal 108 associated with the main lobe covering the talker is completely muted. For example, talker T2 may be within the main lobe of another pickup pattern (not illustrated). If the audio signal 108 associated with that pickup pattern is completely muted, audio from talker T2 may still be present as talker T2 may be within the side lobe 130b of pickup pattern 130.

Previous uses of wired or wireless microphones included mute controls to mute or unmute a specific microphone. With the advent of a BMA 102 with good audio performance that can be installed far from the talker, the microphones of the BMA 102 may be installed in or near the ceiling (e.g., in place of a ceiling tile) or in another location. An example of a BMA 102 integrated with a ceiling tile such as found in USPN 10728653, which allows the microphones to blend in with the décor and reduces clutter on the table. A BMA 102 may eliminate the need for a device, such as a wireless handheld microphone, to be passed from person to person.

In some embodiments, the processor 104 may be configured to perform other operations. For example, the audio signals 108 may be processed by an automatic mixer configured to perform various audio processing functions, such as implementing a “gating” function that applies attenuation to audio signals 108 that have very low signal energy, while not attenuating other audio signals 108 that have high signal energy. In some embodiments, the BMA 102 includes a voice activity detector, so that the undesired noise does not activate an audio signal 108 while allowing voice to activate the audio signal 108. In some embodiments, the processor 104 may be configured to perform de-noising. Artificial intelligence, machine learning, or deep learning networks may be implemented by the processor to denoise and/or mute beamformed audio containing speech. For example, a deep learning network may be trained on a pre-recorded database of non-speech sounds, noises, and speech sources. Examples of noises include keyboard strokes, dogs barking, babies crying, sirens, washing machines, or any undesirable noise that perturbs the clarity of speech. After training, the processor 104 may be configured to significantly suppress the non-speech noise, while allowing speech to be transmitted. As a result, speech may be separated from a noisy environment for improved speech clarity. In some embodiments, the processor 104 may be configured to provide information that sound is coming from predefined undesired areas. During these times the processor 104 may block the incoming audio signal 108, prevent selection or usage of the audio signal 108, or cause a change in steering so that the undesirable audio is not added to the output audio signal 110. Examples of undesired areas may include nearby spaces that are outside of the meeting area such as hallways, outdoors, windows, adjacent meeting spaces, desks, and adjoining rooms.

In some embodiments, the processor 104 may be configured to identify sound sources in particular audio signals 108 associated with pickup patterns 130 that cover regions from which a probability of receiving desired audio may be low. For example, a target talker's speech may captured in a set of one or more audio signals 108 from the BMA 102. Sound sources detected in audio signals 108 associated with pickup patterns 130 that do not cover the target talker may be identified as being interfering sound sources. The processor 104 may be configured to identify the interfering sounds sources and mute those sound sources in the audio signals 108. Thus, even if some portion of the audio signals 108 including the target talker also includes audio from the interfering sound sources, those sound sources may be muted. In some embodiments, the processor 104 may be configured to operate in a mode in which a target talker's voice is the only sound source that is not muted.

In some embodiments, a talker recognition system is described. The embodiment learns to identify different talkers in real time, rather than using a database of recorded speech. The embodiment optionally includes the ability to segment captured speech in real time by including a look-ahead buffer (not shown) that represents 20 to 100 milliseconds worth of digitized speech. This buffer, if implemented, is used to allow the system to identify transitions from one talker to another with higher confidence than can be done with an embodiment that does not implement a look ahead buffer. Speech is captured and analyzed in real time and the system buffer is used to allow the system to analyze a few tens of milliseconds of speech in order to decide whether to mute or unmute speech in a given beam.

The mute function 106 integrates with BMA 102 and helps the processor 104 to identify different talkers because in many cases, different talkers are picked up by one or more audio beams 108. The system optionally incorporates camera tracking with one or more cameras 140 and a face recognition and mouth movement detection function that helps the embodiment associate identified voices with the faces of participants in a room. This can be beneficial if multiple talkers with similar voices are being picked up by a single audio beam by BMA 102. In this situation, the face recognition and mouth movement detection function can help the embodiment distinguish between the different talkers. This can help the embodiment perform more accurate training if two talkers with similar-sounding voices are being picked up by a single audio beam 108.

Some embodiments train their respective machine learning, artificial intelligence, or deep learning neural networks in real time. The embodiments accumulate a set of databases of speech from specific talkers during use of the embodiment and identifies different talkers by training itself to identify those different talkers using known speaker identification technologies. After the embodiment has accumulated a sufficient amount of data to distinguish between the different talkers in a given session, an indicator is presented to users of the system that the embodiment is ready to implement the automated mute/unmute function. Prior to this indication, the embodiment mute/unmute functions are not available, so the embodiment operates in a training mode when it is initially installed, and then transitions to an operating mode after being trained on a set of specific talkers. In the case when a new user joins a meeting and the AI mute function is enabled, the automatic AI mute features previously learned apply to the previous users and the system learns the new recent talker.

Some embodiments implement a mode in which it is trained to enable only a target talker's voice to pass through. In this mode, the target talker's speech is captured in a pre-defined set of one or more audio beams 108 from the BMA 102. In this mode, all speech detected as propagating from a direction of look of the BMA 102 outside of the predefined target directions or beam patterns 130 are identified as being interfering speech, while speech captured from the pre-defined set of target beams or beam patterns 130 is identified as desired speech. In this mode, the embodiment can learn to “mute” all audio coming from undesired directions by suppressing that audio even if some portion of that audio is captured by an audio beam looking in a target direction.

Some embodiments implement an “exclusion zone” in the pickup area of BMA 102 if the BMA is combined with a direction of arrival determination and/or function. This technique is similar to the “cone of silence” described elsewhere in the current disclosure. Rather than implementing a user interface control to mute a particular talker's voice wherever that talker is located in the pickup area of a BMA, an installer, user, or producer, could define an exclusion zone that consists of a particular beam, or an area covered by multiple beams. When a source is within the exclusion zone as determined by the Direction of Arrival (DOA) function, the AI noise reduction could remove it from all the audio signal 108 transmitted by the BMA. If a talker or source (the same or different source) is outside of the exclusion zone, the audio signal from that source would not be removed from the transmitted audio 110.

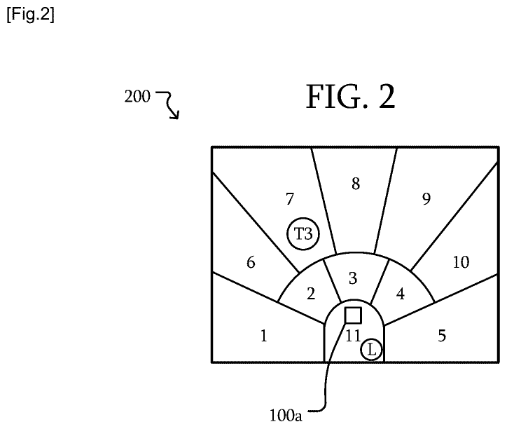

FIG. 2 is a diagram of a room 200 with a system 100a including a beamforming microphone array and a muting function according to some embodiments. With reference to the other embodiments, the system 100a will be used as an example; however, in other embodiments, such as described in systems 100b, 100c, 100d, 100e or the like, may be used in the room 200. The room 200 is an example of an auditorium, a classroom, a lecture hall, a city council meeting, a school council meeting, a panel discussion with a group of council members seated at a table, each with an audience, or the like. In some embodiments, all sound sources are muted except the sound source corresponding to the person who “has the floor.”

The system 100a includes 11 pickup patterns with main lobes disposed to cover the corresponding regions of the room 200. Here, regions 1, 5, and 11 represent regions where a lecturer L may be present, such as a stage, podium, whiteboard, or the like where the lecturer L may stand or walk in a particular area of the room 200. Regions 2, 3, 4 and 6, 7, 8, 9, 10 represent regions where an audience may attend the presentation.

Audio from the lecturer L may be captured and recorded or transmitted to remote conference participants. The lecturer L may be an identified sound source that is capable of being muted as described above; however, the lecturer L may not be muted. Audio signals 108 associated with pickup patterns covering regions 1, 5, and 11 may contribute to the output audio signal 110.

A talker T3 may be present in the audience in regions 2-4 and 6-10. Using region 7 as an example of a region with the talker T3, audio from talker T3 may be present in an audio signal 108 associated with a pickup pattern covering region 7. While that audio signal 108 may be completely muted, audio from talker T3 may still be present in the audio signals 108 associated with regions 1, 5, and 11.

In addition, the lecturer L, a producer, or other person may enable one or more of the regions 2, 3, 4 and 6, 7, 8, 9, 10 for questions from the audience. For example, regions 2 and 4 may be enabled so that the audio signals 108 associated with those regions are added to the output audio signal 110. This addition may otherwise exacerbate the contribution of audio from talker T3. Regardless of how the audio from talker T3 appears in the audio signals 108, talker T3 may be muted in the audio signals 108 associated with the regions 1, 2, 4, 5, 11 and/or other regions from which the audience may ask questions.

In some embodiments, the muting function 106 may be performed in conjunction with muting an audio signal 108. For example, if talker T3 is the only identified sound source in region 7, the audio signal 108 associated with region 7 could be entirely muted or excluded from the modified output signal 110. As a result, a significant portion of the contribution of talker T3 may be eliminated. However, audio from the talker T3 may still appear in other audio signals 108, such as those associated with regions 2, 3, 6, and 8. The mute function 106 may be performed on the remaining audio signals 108. In some embodiments, the audio signal 108 associated with a particular region may be entirely muted or excluded only if all identified sound sources in that region are muted. In some embodiments, audio signals 108 associated with regions adjacent to the region including a talker to be muted may also be entirely muted or excluded from the modified output signal 110. For example, audio signals 108 associated with regions 2, 3, 6, and 8 that are adjacent to talker T3 may also be entirely muted or excluded from the modified output signal 110. In some embodiments, the selection of audio signals 108 that are entirely muted may depend on the pickup patterns, side lobes, or the like associated with the audio signals 108.

In some embodiments, the audio signals 108 associated with regions that are entirely muted or excluded from the modified output signal 110 are all regions other than those that contain desired audio. For example, all regions other than 1, 5, and 11 may be entirely muted or excluded from the modified output signal 110. Thus, if the lecturer L moves from region 1 to 11, 11 to 5, or the like, the audio from the lecturer L will still be part of the modified audio signal 110. Audio from any other region is reduced or eliminated through both entirely muting or excluding the associated audio signals 108 from the modified output signal 110 and in conjunction, selectively muting sound sources in those other regions on audio signals 108 associated with regions 1, 5, and 11.

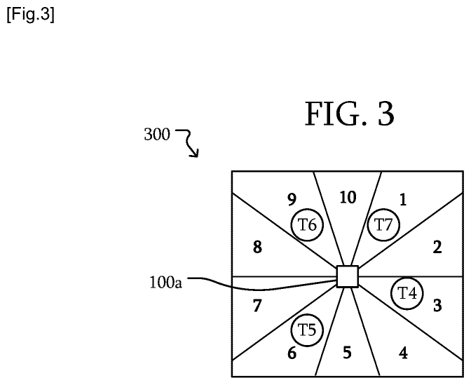

FIG. 3 is a block diagram 300 of another room with a system including a beamforming microphone array and a muting function according to some embodiments. Referring to other drawings, in some embodiments, the room 300 may include a system 100a like room 200 as described above. However, the regions and associated pickup patterns of the BMA 102 may be different. Here, the system 100a may be installed in a center of the room 300. The pickup patterns 1 through 10 may radiate from that central location.

In this example, four potential talkers T4, T5, T6, T7 are present in the room 300. The talkers T4 though T7 may be seated around a conference table in the room 300. Each of the talkers T4 through T7 may be capable of controlling whether that talker's audio is muted. As will be described in further detail below, the talkers T4 through T7 may each have access to a user interface enabling each talker to selectively mute his or her audio.

Although an auditorium and a conference room have been used as examples of locations where a system 100a may be used, the system 100a may be used in different locations. For example, a system 100a may be used in a professional home office that is typically used by one or a small number of people. Occasionally, potential sound sources or talkers such as children, a spouse, a roommate, or the like may enter the home office and contribute to one or more of the audio signals 108. In another example, a system 100a may be used in a courtroom in which a judge, attorneys, witnesses, jurors, or the like may be potential sound sources. In some embodiments, certain sound sources, such as those of the jury, may be muted by default. These sound sources may be selectively muted as described in this disclosure.

In some embodiments, the mute function 106 may be configured to mute a variety of talkers. For example, the mute function 106 may be configured to mute all talkers present in a particular audio signal 108. In another example, the mute function 106 may be configured to mute all sound sources except for the speech of one desired talker. This operation may be useful in an open office environment where multiple workspaces for several different people are located close to the workspace of the main user of the system 100b. By muting all but a target talker, the system 100a would effectively implement a “cone of silence” around the desired talker, muting speech from all interfering talkers located in adjoining workspaces.

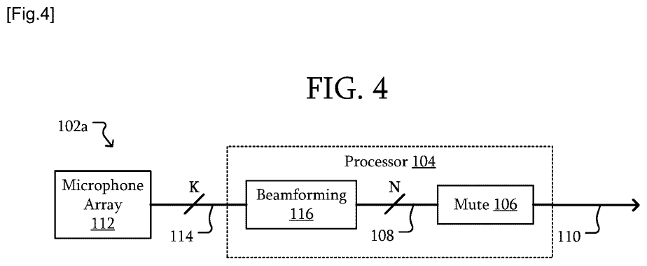

FIG. 4 is a diagram of a beamforming microphone array 102a with a muting function according to some embodiments. In some embodiments, the BMA 102a may be similar to the system 100a described above and include similar components. The BMA 102a may include a microphone array 112. The microphone array 112 includes multiple microphones. Each microphone may be configured to generate a corresponding microphone audio signal 114. Here, K microphone audio signals 114 are generated by corresponding K microphones where K is a positive integer greater than one.

The processor 104 is configured to perform a beamforming operation 116. The beamforming operation 116 may use the K microphone audio signals 114 to generate the N audio signals 108. The processor 104 may operate as described in this disclosure to generate the modified audio signal 110 in response to the N audio signals 108. Accordingly, the selective muting operations 106 of the system 100a may be contained within a BMA 102a.

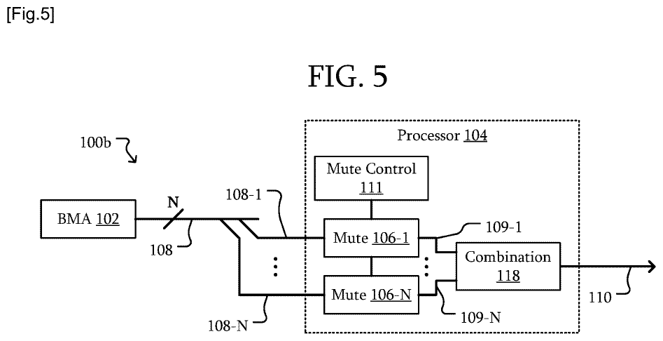

FIG. 5 is a block diagram of a system 100b including a beamforming microphone array and a muting function for multiple beams according to some embodiments. The system 100b may be similar to the system 100a described above. However, in the system 100b, the BMA 102 is configured to generate N audio signals 108 where N is two or more that includes audio signals 108-1 through 108-N. The processor 104 is configured to perform a mute function where each of the N audio signals 108-1 through 108-N is associated with a corresponding mute function 106-1 through 106-N. The corresponding mute function 106-1 through 106-N generates selectively muted audio signals 109-1 through 109-N.

In some embodiments, each of the mute functions 106-1 to 106-N may be configured to perform the same operation. For example, each of the mute functions 106-1 to 106-N may be configured to mute talker T2. While muting talker T2 is used as an example, the mute functions 106-1 to 106-N may be configured to mute other talkers, mute multiple talkers, mute different talkers, mute different sets of targets, or the like. The set of talkers that the mute functions 106-1 to 106-N are muting may change over time. In some embodiments, for at least some of the audio signals 108, the associated mute function 106 will not operate and will instead pass the audio signal 108 as the associated selectively muted audio signals 109. In addition, the set of talkers or other sound sources that the mute functions 106-1 to 106-N mute may be different among the mute functions 106-1 to 106-N.

The processor 104 may be configured to perform a combination function 118. The combination function 118 is configured to generate the modified output signal 110 based on the selectively muted audio signals 109-1 to 109-N from the muting operations 106-1 to 106-N. The combination function 118 may be configured to combine each of the selectively muted audio signals 109-1 to 109-N, combine less than all of the selectively muted audio signals 109-1 to 109-N, mix the contribution of the selectively muted audio signals 109-1 to 109-N differently, or the like to generate the modified output signal 110.

As described above, each of the mute functions 106 may be configured to mute the same sound source. For example, talker T2 may be present in each of the audio signals 108. While the amplitude of the contribution of talker T2 in each of the audio signals 108 may be different, the mute function 106 may be performed to mute talker T2 in every audio signal 108. As a result, in the modified output signal 110, the contribution of talker T2 through any of the audio signals 108 may be reduced or eliminated.

In some embodiments, the processor 104 may be configured to perform a mute control function 111. The mute control function 111 may be configured to provide signals, parameters, or the like to some or all the mute functions 106 such that each mute functions 106 may be configured to mute one or more sound sources. For example, the mute control function 111 may be configured to provide parameters that allow the mute functions to identify target sound sources, distinguish target sound sources from other talkers, interfering talker, noise, or the like. The mute control function 111 may be configured to control whether the mute functions 106 mute one or more sound source, mute the entire audio signal 108, or the like. In some embodiments, the control provided by the mute control function 111 may be different for each mute function 106.

In some embodiments, the processor 104 may be configured to select an audio signal 108 for transmission or further processing by measuring the speech power in that audio signal 108. The audio signal 108 with the largest power becomes the selected audio signal 108 for further processing or transmission. The combination function 118 may perform this operation. However, the combination function 118 may perform a different operation depending on the conditions. For example, it is possible that the audio signal 108 with the most speech power is not the audio signal 108 with the best signal quality for a target talker. In fact, the audio signal 108 with the most speech power may be an audio signal 108 that contains mostly speech that the system 100b is attempting to mute. After all interfering talker's voices have been muted by the mute functions 1061 to 106-N, the combination function 118 may select the from among the muted audio signals 109-1 to 109-N to output the muted audio signal 109 with the largest power. As this is performed after the muting functions 106 have been performed, the remaining audio in the muted audio signals 109-1 to 109-N may represent desired audio. As a result, an improved signal quality for the target talker(s) may be achieved.

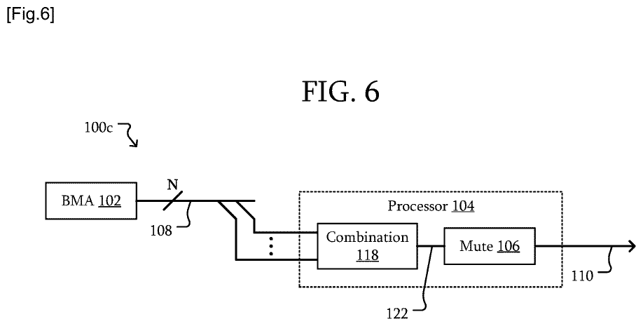

FIG. 6 is a block diagram of a system 100c including a beamforming microphone array 102 and a muting function 106 for a combined audio signal according to some embodiments. The system 100c may be similar to the systems 100a-b as described above. However, the processor 104 is configured to combine the 1 through N audio signals 108 in the combination function 118 into a combined audio signal 122. The mute function 106 is performed on the combined audio signal 122 to generate the modified audio signal 110. That is, the mute function 106 may be performed to selectively mute a sound source in the combined audio signal 122. In some embodiments, the combination function 118 may reduce a computational complexity of the system 100c. By combining the audio signals 108 into a combined audio signal 122, only a single mute function 106 may be used to selectively mute a desired sound source.

In some embodiments, the combination function 118 may be configured to select an audio signal 108 from among multiple audio signals 118. Thus, the combined audio signal 122 may include contributions from only one associated pickup pattern 130 of the BMA 102. As described above, an audio signal 108 with the largest power may be selected; however, in other embodiments, different criteria may be used to select an audio signal 108. Sound from a talker to be muted, such as talker T2, may still be present in a single audio signal 108 even if the talker is not within the main lobe 130a.

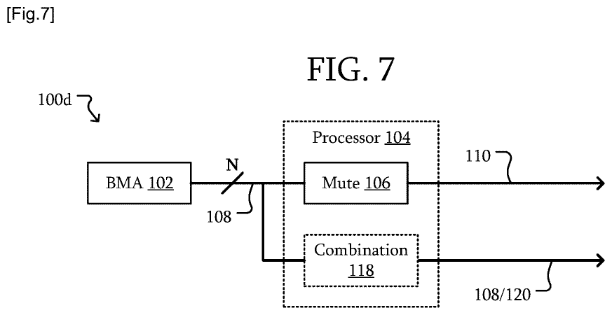

FIG. 7 is a block diagram of a system 100d including a beamforming microphone array 102 and a muting function 106 and an unmuted output 108/120 according to some embodiments. The system 100d may be similar to the systems 100a-c as described above. However, the system 100d may output the audio signals 108 without muting in addition to the modified audio signal 110. In some embodiments, a combination function 118 may be performed on the 1 through N audio signals 108 as described above to generate a combined audio signal 120. Similarly, the combined audio signal 120 is not muted. In some embodiments, any combination of one or more of the audio signals 108 and the combined audio signal 120 may be output.

In some embodiments, all sound sources may be available in the audio signals 108 and/or the combined audio signal 120. For example, the audio may be recorded, some or all voices may be transcribed individually or collectively, or the like, to make a record of a meeting. While for participants, it may be desirable to have some sound sources muted for a live transmission, for a complete record, audio from all of the sound sources may be made available.

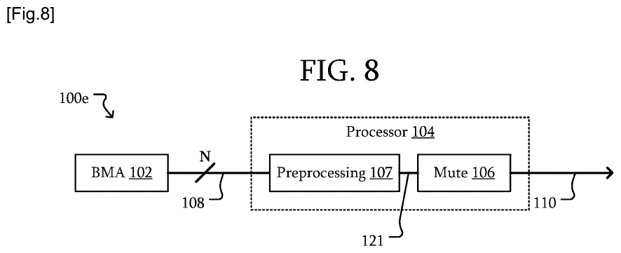

FIG. 8 is a block diagram of a system 100e including a beamforming microphone array 102 and a muting function 106 and additional preprocessing 107 according to some embodiments. The system 100e may be similar to the systems 100a-d as described above. In some embodiments, the processor 104 is configured to perform a preprocessing function 107 on the 1 through N audio signals 108 to generate preprocessed audio signals 121. The preprocessed audio signals 121 may be processed as the audio signals 108 as described above with respect to systems 100a-d.

In some embodiments, the preprocessing 107 includes acoustic echo cancellation (AEC). For example, the system 100d may be part of a conference system with local and remote locations. A remote audio signal from the remote location may be combined with the audio signals 108 in the preprocessing to substantially reduce or eliminate the contribution of the remote audio signal to the audio signals 108, the modified audio signal 110, the combined audio signal 120 or the like. Although AEC has been used as an example of the preprocessing function 107, in other embodiments, other types of additional processing may be performed on the audio signals 108.

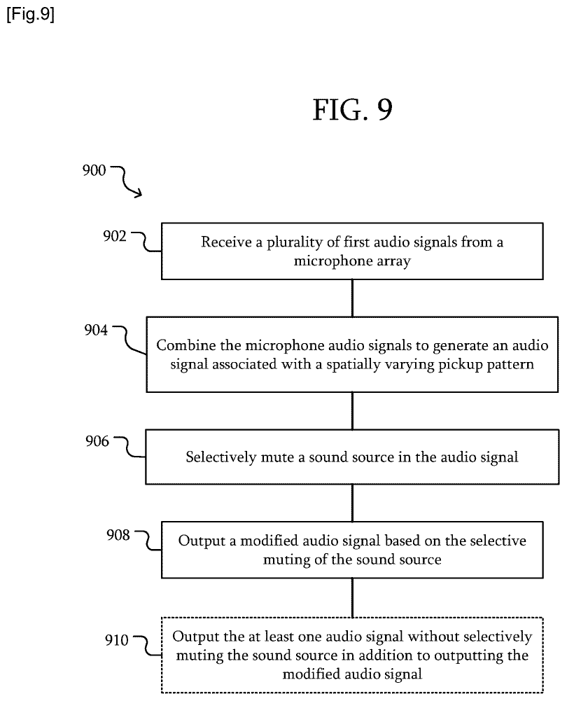

FIG. 9 is a flowchart of an operation of a method 900 including a beamforming microphone array and a muting function according to some embodiments. Referring to other drawings, the system 100a will be used as an example; however, in other embodiments, the systems 100b-e or the like may be configured to perform the operations described in this disclosure.

In step 902, microphone audio signals are received from a microphone array. For example, the BMA 102 or 102a may be configured to receive audio from multiple microphones of a microphone array 112. The BMA 102 or 102a may be configured to generate the microphone audio signals corresponding to the microphones of the microphone array 112. In some embodiments, each microphone audio signal corresponds to one of the microphones on a one-to-one basis.

In step 904, the microphone audio signals are combined to generate at least one audio signal where each audio signal is associated with a spatially varying pickup pattern. For example, the BMA 102/102a may be configured to perform a beamforming function 116 to generate the audio signal(s) 108 as the audio signal(s) to generate audio signals 108 with spatially varying pickup patterns. As described above, one or more audio signals 108 may be generated. Thus, one or more audio signals may be generated. Thus, the audio signal or signals are each associated with a spatially varying pickup pattern as described above.

In step 906, a sound source in the at least one audio signal is selectively muted. For example, the mute function 106 may selectively mute a sound source in the audio signal. In some embodiments, the muting is performed on each of the audio signals individually as in the system 100b. In other embodiments, the muting is performed on a combined audio signal 122 as in system 100c.

In step 908, a modified audio signal is output based on the selective muting of the sound source. For example, each audio signal 108 may be selectively muted and combined as in the system 100b. The combined audio signal may be output as the modified audio signal. In another example, the audio signals 108 may be combined and the combined audio signal is selectively muted as in the system 100c. Outputting the modified audio signal includes the output of these types of audio signals.

In step 910, the at least one audio signal may optionally be output without selectively muting the sound source in addition to outputting the modified audio signal. As described in the system 100d, the audio signals 108 may be output, the audio signals 108 may be combined and output as combined audio signal 120, or the like.

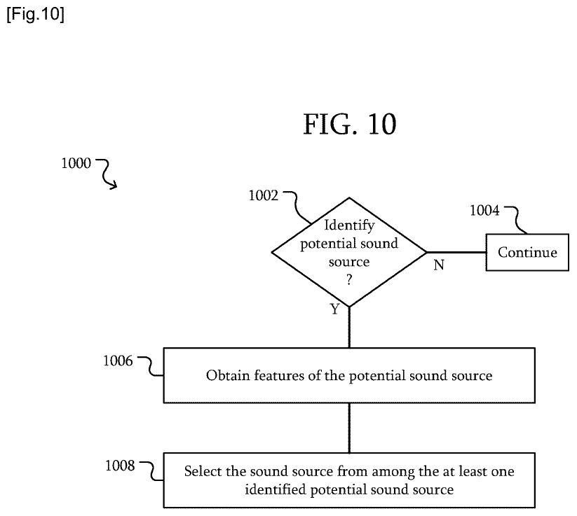

FIG. 10 is a flowchart of a method 1000 for identifying a potential sound source in a system including a beamforming microphone array and a muting function according to some embodiments. Referring to other drawings, the system 100a will be used as an example; however, in other embodiments, the systems 100b-e or the like may be configured to perform the operations described in this disclosure.

In step 1002, at least one potential sound source may be identified in the at least one audio signal. If a potential sound source is not identified, the operation of the system may continue without muting that sound source in step 1002. Identifying the potential sound source may be performed during the operation as previously described. That is, the system 100a may be operating whether muting a sound source. The identification of the potential sound source in step 1002 may be the first identified sound source or a later identified sound source. Examples of a potential sound sources include sound from a different direction, a different audio signal 108, or the like.

In some embodiments, the BMA 102 may be used to help identify a potential sound source. For example, the direction of arrival of a potential sound source can be used to help determine whether the sound is from the same sound source, or a different sound source.

Information about the speech power captured by a particular audio signal 108 can be used by the processor 104 to help distinguish between the voices of talkers with similar speech characteristics. If similar-sounding talkers are located such that their audio is picked up at different power levels by different audio signal 108, the processor 104 can use that information to help decide whether similar sounding voices are from the same talker. This may help the processor 104 decide whether to mute audio from a talker or not. For example, two talkers (talker 1 and talker 2) with similar voices may be sitting at opposite ends of a meeting room. If the system has been configured to mute the speech of talker 1, but determines that it appears that the voice of talker 1 is coming from opposite ends of a room within the very short period of time needed to activate the different audio signals 108 with pickup patterns covering those opposite ends of the room, the processor 104 can determine that it is not able to identify the target talker's voice with enough confidence to make the mute function available without further enrollment and model training.

If a potential sound source is identified in step 1002, features of the potential sound source are obtained in step 1004. This operation may be performed in real time, that is, in parallel with the operations as previously described. In some embodiments, the processor 104 may implement a neural network, deep-learning network, machine-learning algorithm, artificial-intelligence algorithm, or the like. The network or algorithm may be trained by accumulating a database of speech from specific talkers during use of the system 100a. The identification of a talker may be performed by using known speaker identification techniques. In some embodiments, this operation may be performed in real time, in the field, or the like rather than or in addition to using a database of recorded speech.

In some embodiments, to identify a particular talker, the processor 104 may be pre-trained to identify a set of different talkers. Examples of methods of identifying different talkers are described in “Speaker Diarization with LSTM,” (full cite below), which is incorporated by reference for all purposes into this disclosure. The identification may use databases like those available from the Linguistic Data Consortium such as the 2000 NIST Speaker Recognition Evaluation database (available at https://catalog.ldc.upenn.edu/LDC2001S97). The pre-training database may be used to bootstrap the identification of talkers. For example, the processor 104 may be trained to identify any of the N talkers in the database. When presented with a new talker during enrollment, the system would attempt to identify which of the N database talkers the new voice was closest to. Recorded speech, or extracted speech features, such as MEL frequency cepstral coefficients, from the new talker would be used to replace speech, or extracted speech features, in the database from the closest database talker. Alternatively, the processor 104 may start without a pre-trained database and simply accumulate a database of speech information from scratch during an enrollment phase.

NPL1: “Speaker Diarization with LSTM,” Q. Wang, C. Downey, L. Wan, P. A. Mansfield, I. L. Moreno, Proceedings of the International Conference on Acoustics, Speech, and Signal Processing (ICASSP), 2018.

In some embodiments, after each use of the system 100a, new recorded speech would be used to re-train the speaker identification models, enabling the system to identify a talker better when the system 100a is used in the future by that same talker. That is, the memory 105 may be configured to store data representing the previously trained state.

In some embodiments, the operations described in this disclosure to identify sound sources, obtain features, and otherwise prepare to selectively mute a sound source may be performed before operating the system 100a to selectively mute a sound source. For example, before a session begins, a training session or an enrollment session may occur where one or more talkers may identify themselves, speak, or otherwise provide input to the system such that when a session begins, the system 100a is prepared to mute or pass audio from that particular talker as described in this disclosure. In a particular example, each talker may be presented with a prompt to speak for a period of time, read out loud a particular text, or the like. The system 100a may match a particular talker with an existing identified talker and/or add the talker as a new talker to be selectively muted.

In some embodiments, the processor 104 may be configured to incorporate a confidence score along with its identification indicating the likelihood that an utterance belongs to a talker in the database. Use of a pre-training database may be beneficial during enrollment to help distinguish between the voices of multiple talkers who are sitting close to each other in a room so that speech from those talkers is captured by the same beam of the beamformer.

In some embodiments, the processor 104 does not initially know how many sound sources are present, whether the sound sources are moving, or the like. For example, when the system 100a is activated, a lecturer L as described above may be presenting in the room 200. The speech pattern, speech cadence, vocal characteristics, time varying parameters, or the like of the lecturer L may be identified. If there is a change, that change may indicate the presence of a different sound source, such as talker T3. The uniqueness of a talker's voice and characteristics that reflect that uniqueness may be used to classify that sound as from that particular talker.

In some embodiments, the processor 104 determines a number of talkers in the room. Features of each talker may be obtained and used to train a model for the talker. These talkers with associated trained models may become a set of recognized talkers for a session during an enrollment or training period.

In some embodiments, the audio that is analyzed may be each of the audio signals 108, a combined audio signal 122, a modified audio signal 110, or the like. For example, while the mute functions 106 may be performed on audio signals 108 or a combined audio signal 122 during a normal operation of the system 100a, audio that is used for training, extracting features, or the like may come from a different set of the audio signals 108 and the combined audio signal 122.

In some embodiments, the obtaining of the features in 1006 may be performed before any muting is performed. Once features of at least one sound source to be muted are obtained, the system 100a may allow that sound source to be selected to be muted. As more sound sources are identified and features are obtained to characterize the sound sources, those sound sources may be added to a set of sound sources capable of being muted.

In some embodiments, obtaining features of the potential sound source in 1006 includes training a neural network, deep-learning network, machine-learning algorithm, artificial-intelligence algorithm, or the like to recognize the at least one potential sound source while receiving the microphone audio signals. The trained network or algorithm may be used to selectively mute the sound source if that sound source is selected in 1006.

In some embodiments, the processor 104 may be configured to perform a real time diarization function to identify a sound source. An example of real time diarization is disclosed in “A Real-Time Speaker Diarization System Based on Spatial Spectrum,” (cited below), which is incorporated by reference for all purposes into this disclosure.

NPL2: “A Real-Time Speaker Diarization System Based on Spatial Spectrum,” S. Zheng, W. Huang, X. Wang, H. Suo, J. Feng, Z. Yan, Proceedings of the International Conference on Acoustics, Speech, and Signal Processing (ICASSP), 2021.

Using the output of the diarization, the processor may be configured to control which sound sources should be muted or unmuted at any given time. The processor 104 is configured to perform a speech separation function that separates audio from the one or more audio signal 108 into audio from individual sound sources. For example, if two people speak at the same time, the speech separation function can separate the single captured stream of audio representing the sum of both talkers into two separate streams of audio representing the speech of the individual talkers. An example of a speech separation function is disclosed in “Online Self-Attentive Gated RNNs for Real-Time Speaker Separation,” (cited below), which is incorporated by reference for all purposes into this disclosure. Another example is disclosed in “Voice Separation with an Unknown Number of Multiple Speakers,” (cited below), which is incorporated by reference for all purposes into this disclosure. When only a single person is talking, the speaker separation function separates the input audio into a voice on one channel, and noise on the other channel. If multiple people talk at the same time, the system can separate the summed speech into several separate streams of audio.

NPL3: “Online Self-Attentive Gated RNNs for Real-Time Speaker Separation,” Workshop on Machine Learning in Speech, and Language Processing, 2021.

NPL4: “Voice Separation with an Unknown Number of Multiple Speakers,” E. Nachmani, E. Adi, L. Wolf, Proceedings of the 37 the International Conference on Machine Learning, Vienna, Austria, PMLR 119, 2020.

In some embodiments, the identification of the potential sound source in 1002 may be performed with additional information. Such additional information may include a video associated with a potential sound source may be used as part of identifying a potential sound source, facial recognition associated with the at least one potential sound source, and mouth-movement detection associated with the at least one potential sound source, or the like.

In some embodiments, mouth movement detection may be performed on the video generated by the camera 140. When mouth movement is detected in one portion of the video, the current audio may be associated with a first sound source. When mouth movement is associated with a spatially different portion of the video, the current audio may be associated with a second sound source. Accordingly, sound in the audio signals 108 may be categorized by sound source.

In some embodiments, noise-suppression or noise-reduction algorithms may also be performed by the processor that estimate speech from noise. This may reduce a probability that impulse and/or diffuse noise sources are counted as an active sound source and thus further help prevent the camera 140 moving to the noise source and potentially being identified as a sound source.

In some embodiments, the facial recognition and mouth-movement detection may be combined. As a result, even if a talker moves, the association of the facial recognition and the mouth movement detection may improve the identification of the current audio as being associated with a particular sound source. In particular, in some embodiments, multiple talkers may be present in a single pickup pattern 130. Facial recognition and mouth-movement detection may help the processor 104 distinguish between different talkers. This may help the processor 104 perform more accurate training if two talkers with similar-sounding voices contribute to the audio signals 108.

In some embodiments, when a new talker enters a room, the processor 104 may enter a training or enrollment period where features of the identified potential sound source are obtained in step 1004 such that the potential sound source may be selected as a sound source to be muted. That is, the identified potential sound source may be added to a list of available sound sources that may be selectively muted. In some embodiments, when a potential sound source is identified and features are obtained so that the sound source may be muted, the sound source may be unmuted by default.

In some embodiments, the obtaining of features in step 1004 may be based on different pickup patterns. As previously described, audio from regions 1, 5, and 11 may be defined as desired audio while audio from regions 2-4 and 6-10 are defined as not desired. The combination of regions 2-4 and 6-10 may be defined as a sound source to be muted. The sound from regions 2-4 and 6-10 may be used as the source of audio for obtaining the features in 1002. That is, the regions 2-4 and 6-10 may be considered a single sound source that may be muted in audio signals 108 associated with regions 1, 5, and 11.

In some embodiments, the BMA 102 may be configured to provide information on its overall “direction of look,” such as a direction of a main lobe 130a of the pickup pattern 130. The BMA 102 may also be configured to provide an estimate of the distance of from the BMA 102 to a sound source. These attributes of the BMA 102, the pickup patterns associated with audio signals 108 or the like may be used to aid in distinguishing one sound source from another.

In some embodiments, audio may be delayed allowing for the various operations described in this disclosure. For example, the speaker separation and/or diarization process may require some latency, such as, for example, a delay of about 20 milliseconds (ms), 60 ms, 140 ms, or the like. This delay may allow for an increased confidence in the accuracy of the operations. To perform the mute function 106, if a diarized talker is identified as a talker who should be muted in step 1008, the separated speech is subtracted from the input audio after the input audio has been delayed so that the input audio is aligned with the separated speech and the diarized indicator of who is currently talking.

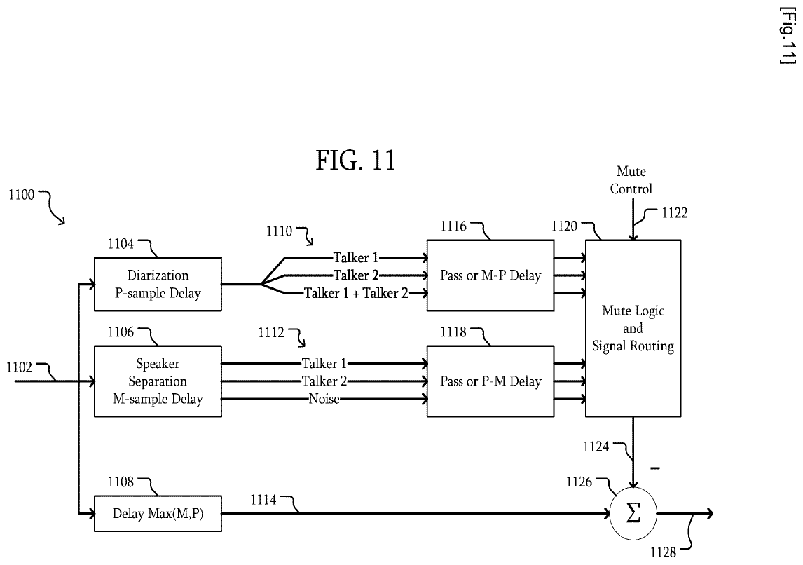

FIG. 11 is a block diagram of an audio signal flow 1100 according to some embodiments. Referring to other drawings, the system 100a will be used as an example. An audio signal 1102 may be received. The audio signal 1102 may be a single audio signal 108, a combination of the audio signals 108, all the audio signals 108, or the like. A diarization function 1104 may perform diarization on the audio signal 1102. The diarization function 1104 may have a delay of P samples. The output of the diarization function 1104 may include an indication 1110 of one or more current sound sources. Here, two sound sources, Talker 1 and Talker 2 are used as an example; however, in other embodiments, the number of sound sources may be different. The diarization function 1104 may be configured to generate the indication 1110 that indicates whether Talker 1 is present in the audio signal 1102, Talker 2 is present in the audio signal 1102, both Talker 1 and Talker 2 are present in the audio signal 1102, or none are present in the audio signal 1102.

A speaker-separation function 1106 is configured to separate sound sources as described above. In this example, the speaker-separation function 1106 may be configured to separate the audio signal 1102 into separated audio signals 1112 for Talker 1, Talker 2, and Noise. The speaker-separation function 1106 may have a M sample delay. The M sample delay of the speaker-separation function 1106 may be the same or different from the P sample delay of the diarization 1104. Pass/delay operations 1116 and 1118 may be respectively performed on the identification 1110 and the separated audio signals 1112. For example, if M is greater than P, the pass/delay 1116 may delay the indication 1110 by M-P samples and the pass/delay 1118 may pass the separated audio signals 1112. Alternatively, if P is greater than M, the pass/delay 1116 may pass the indication 1110 and the pass/delay 1118 may delay the separated audio signals 1112 by P-M samples. The audio signal 1102 may be delayed by a delay 1108 equal to the maximum between M and P samples. As a result, the audio signal 1102, the identification 1110, the separated audio signals 1112 may be aligned in time when operated on by a mute logic and signal routing function 1120. Although compensating for the delay of the diarization function 1104 and the speaker-separation function 1106 has been used as an example, the delays may be different to account for delays of other operations so that the various signals are aligned in time.

The mute logic and signal routing function 1120 may be configured to generate a muting audio signal 1124 that is subtracted from the delayed audio signal 1114 in a summation function 1126 to generate a modified audio signal 1128. The modified audio signal 1128 may be the modified audio signal 110 or the muted audio signal 109 described above. The mute control 1122 may indicate which sound source or sources, if any, are to be muted. The mute logic and signal routing function 1120 may select and/or combine the separated audio signals 1112 as appropriate to generate the muting audio signal 1124 with the desired components to be muted.

Although the subtraction of a separated audio signal 1112 has been used as an example, in other embodiments, a separated audio signal 1112 may be used to amplify or emphasize a particular sound source. That is, a separated audio signal 1112 may be added to the delayed audio signal 1114 rather than subtracted.

In some embodiments, the muting audio signal 1124 may include processing of a separated audio signal 1112 to change the character of the separated audio signal 1112. For example, the separated audio signal 1112 of a particular talker may be distorted or disguised to prevent identification of the talker. The muting audio signal 1124 may be created to mute the separated audio signal 1112 but also to add in a distorted version of the same separated audio signal 1112.

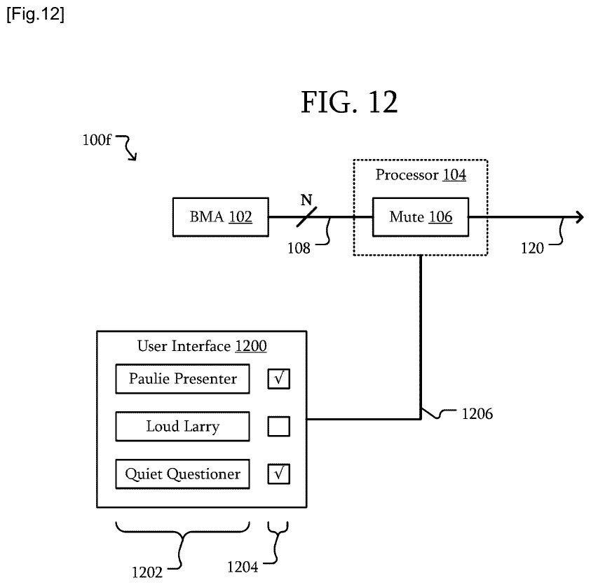

FIG. 12 is a block diagram of a system 100f including a beamforming microphone array and a muting function with a user interface according to some embodiments. The system 100f may be like the system 100a-e described above. However, the system 100f includes a user interface 1200. The user interface 1200 may include a variety of devices. For example, the user interface 1200 may include a mobile device, cell phone, tablet computer, desktop computer, touch screen, or the like.

The user interface 1200 may be configured to present controls such that recognized sound source may be selectively muted. For example, a display may present a list 1202 of currently identified talkers. Each of the currently identified talkers may be associated with one of a set of controls 1204. The controls 1204 may indicate that the associated talker should be muted. Here, only “Loud Larry” is selectively muted by the mute function 106 with “Paulie Presenter” and “Quiet Questioner” being unmuted. The user interface 1200 transmits these selections 1206 to processor 104 to select combined audio signal 120.

As described above, new potential sound sources may be identified and characterized so that they may be muted. As new sound sources are identified, the new sound sources may be added to the list 1202. In addition, identified sound sources may be removed from the list 1202. For example, if a sound source has not been present in the 1 through N audio signals 108 for a threshold time period, such as 10 minutes, an hour, or the like, that sound source may be removed from the list 1202.

Although a single list 1202 has been used as an example, the organization of sound sources that may be muted may be presented in different ways. For example, the sound sources may be organized by associated pickup patterns of the BMA 102, associated regions of a room as previously described such as one group being a presenter group in regions 1, 5, and 12, and a second group being an audience group in regions 2-4 and 6-7.

In some embodiments, the user interface 1200 may be presented to users through an app on a mobile device. As a result, each user may have access to mute themselves just as if the user was using a gooseneck or headset microphone with a mute button.

In some embodiments, the user interface 1200 may be configured to indicate that the system 100a is operating in a training mode where it is accumulating enough data to be able to distinguish between the different talkers in each session. The user interface 1200 may present an indicator representing the training mode. The indicator may also indicate whether the training mode is complete and that sound sources may be selectively muted as described above. In some embodiments, the system 100a may present sound sources capable of being muted as soon as they are available while still acquiring data to be able to mute other sound sources.

In some embodiments, the user interface 1200 may include multiple mute/unmute controls. For example, a set of displays (e.g., touchscreen displays) may be permanently installed in or on a conference room table. Each display indicates to users whether the mute function is ready for that person to use. A “ready for use” indicator would activate after a person had spoken for long enough for the system to recognize that it has been trained on that user's voice.

In some embodiments, the displays may initially indicate the recognized user with a generic label such as User #1, User #2, etc. An interface on each touch-screen display may allow each user to edit his/her assigned generic label, and type in his/her name, select an icon or avatar, or the like. In an unmuted state, the name label on all the displays may be highlighted when a recognized user begins talking and all displays would return to an un-highlighted state when that user stops talking. The user could then identify themselves and activate the function to mute his/her voice and subsequently unmute his/her voice. Using this control system, a user could mute himself/herself and then walk around the room. In this state, regardless of where that person was in the room, and regardless of which audio signal 108 from the BMA 102 includes the user's audio, their voice would be muted. All the displays may show that a particular user was muted or unmuted. As a result, if a muted user moves to a different location in the room, they can use a different touchscreen display to unmute their voice than the original touch screen they used to mute their voice.

In some embodiments, an app running on a mobile or wearable device could be used to control the mute/unmute state of a user. This app may have a method to discover and enable user control of the beamforming microphone arrays in a room. The app could display the same information about the detected users in a room described above and their muted or unmuted state. Another alternative technique for controlling the mute/unmute state is a speech-recognition system with a wake word. For example, if the control mechanism is implemented in a mobile app, after linking to the system 100a in a room, a user could speak to their mobile device: “Alexa, mute the audio of user number 1”, or “Cortana, unmute Bob's audio.” In this embodiment, a display on the mobile app would show the list of users whose voices have been recognized by the system, but speech would be used to control muting and unmuting of users rather than touch control.

Some embodiments include means for receiving a plurality of microphone audio signals from a microphone array; means for combining the microphone audio signals to generate an audio signal associated with a spatially varying pickup pattern; means for selectively muting a sound source in the audio signal; and means for outputting a modified audio signal based on the selective muting of the sound source.

Examples of the means for receiving a plurality of microphone audio signals from a microphone array include the processor 104 coupled to the microphone array 112, or the like. Examples of the means for combining the microphone audio signals to generate an audio signal associated with a spatially varying pickup pattern include the processor 104 configured to perform the beamforming 116, the BMA 102, or the like. Examples of the means for selectively muting a sound source in the audio signal include the processor 104 configured to perform the mute function 106 or the like. Examples of the means for outputting a modified audio signal based on the selective muting of the sound source include the processor 104 configured to perform the muting 106, the combination 118, or the like.

While the present disclosure has been described in this disclosure regarding certain illustrated and described embodiments, those of ordinary skill in the art will recognize and appreciate that the present disclosure is not so limited. Rather, many additions, deletions, and modifications to the illustrated and described embodiments may be made without departing from the true scope of the invention, its spirit, or its essential characteristics as claimed along with their legal equivalents. In addition, features from one embodiment may be combined with features of another embodiment while still being encompassed within the scope of the invention as contemplated by the inventor. The described embodiments are to be considered only as illustrative and not restrictive. All changes which come within the meaning and range of equivalency of the claims are to be embraced within their scope. Disclosing the present invention is exemplary only, with the true scope of the present invention being determined by the included claims.

1. An apparatus that mutes specific talkers using beamforming microphone arrays, comprising:
at least one microphone array configured for beamforming where an individual microphone array includes a plurality of microphones where each individual microphone is configured to sense audio signals and the microphone array is configured to generate N audio signals where each audio signal is associated with a spatial pickup pattern, the microphone array(s) are located in a room;
a processor and memory operably coupled to the microphone array, the processor configured to execute the following steps:
selectively mute or unmute an individual talker the room with a mute function that controls whether to mute or unmute the individual talker that is picked up by one or more of the individual audio signals, the mute function includes speech learning that learns to identify different talkers in real time to allow the mute function to identify transitions from one talker to another talker in the room;
output an audio signal based on the selective muting of the talkers in the room.

2. The claim according to claim 1 where the mute function uses one or more of the following techniques to assist in identifying individual talkers: artificial intelligence, machine learning, or deep learning.

3. The claim according to claim 1 that further includes at least one video camera that uses facial recognition and/or mouth-movement detection to assist in the learning and identifying the individual talkers.

4. The claim according to claim 1 that further includes a user interface so that a user can selectively mute a sound source and/or one or more individual talkers.

5. The claim according to claim 1 that further includes a diarization function configured to assist in identifying the individual talkers.

6. The claim according to claim 1 that further includes a speaker separation function configured assist in separating the individual talkers in an audio signal.

7. A method to make an apparatus that mutes specific talkers using beamforming microphone arrays, comprising:
providing at least one microphone array configured for beamforming where an individual microphone array includes a plurality of microphones where each individual microphone is configured to sense audio signals and the microphone array is configured to generate N audio signals where each audio signal is associated with a spatial pickup pattern, the microphone array(s) are located in a room,
operably coupling a processor and memory to the microphone array, the processor configured to execute the following steps:
selectively mute or unmute an individual talker the room with a mute function that controls whether to mute or unmute the individual talker that is picked up by one or more of the individual audio signals, the mute function includes speech learning that learns to identify different talkers in real time to allow the mute function to identify transitions from one talker to another talker in the room,
output an audio signal based on the selective muting of the talkers in the room.

8. The claim according to claim 7 where the mute function uses one or more of the following techniques to assist in identifying individual talkers: artificial intelligence, machine learning, or deep learning.

9. The claim according to claim 7 that further includes at least one video camera that uses facial recognition and/or mouth-movement detection to assist in the learning and identifying the individual talkers.

10. The claim according to claim 7 that further includes a user interface so that a user can selectively mute a sound source and/or one or more individual talkers.

11. The claim according to claim 7 that further includes a diarization function configured to assist in identifying the individual talkers.

12. The claim according to claim 7 that further includes a speaker separation function configured assist in separating the individual talkers in an audio signal.

13. A method to use an apparatus that mutes specific talkers using beamforming microphone arrays, comprising:
beamforming with at least one microphone array where an individual microphone array includes a plurality of microphones where each individual microphone is configured to sense audio signals and the microphone array is configured to generate N audio signals where each audio signal is associated with a spatial pickup pattern, the microphone array(s) are located in a room;
processing with a processor and memory operably coupled to the microphone array, the processor configured to execute the following steps:
selectively mute or unmute an individual talker the room with a mute function that controls whether to mute or unmute the individual talker that is picked up by one or more of the individual audio signals, the mute function includes speech learning that learns to identify different talkers in real time to allow the mute function to identify transitions from one talker to another talker in the room;
output an audio signal based on the selective muting of the talkers in the room.

14. The claim according to claim 13 where the mute function uses one or more of the following techniques to assist in identifying individual talkers: artificial intelligence, machine learning, or deep learning.

15. The claim according to claim 13 that further includes at least one video camera that uses facial recognition and/or mouth-movement detection to assist in the learning and identifying the individual talkers.

16. The claim according to claim 13 that further includes a user interface so that a user can selectively mute a sound source and/or one or more individual talkers.

17. The claim according to claim 13 that further includes a diarization function configured to assist in identifying the individual talkers.

18. The claim according to claim 13 that further includes a speaker separation function configured assist in separating the individual talkers in an audio signal.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)
